(19) United States
(12) Patent Application Publication
(10) Pub. No.: US 2025/0126552 A1
(43) Pub. Date: Apr. 17, 2025

(54) FEATURE LEVEL POWER CALIBRATION

(71) Applicant: Cisco Technology, Inc., San Jose, CA (US)

(72) Inventors: Marisol Palmero Amador, Toledo (ES); Snezana Mitrovic, Leefdaal (BE); Derek W. Engi, Pleasant Ridge, MI (US); Gonzalo A. Salgueiro, Raleigh, NC (US); Joel Richard Goergen, Soulsbyville, CA (US)

(21) Appl. No.: 18/664,101

(22) Filed: May 14, 2024

Related U.S. Application Data
(60) Provisional application No. 63/589,936, filed on Oct. 12, 2023.

(51) Int. Cl. H04W 52/02; H04W 24/04

(52) U.S. Cl. CPC H04W 52/0203; H04W 24/04

(57) ABSTRACT

Devices, systems, methods, and processes for feature level power calibration are described herein. Network devices include sensors that generate sensor readings indicative of various device parameters. A calibration logic utilizes the sensor readings and feature permutations associated with the sensor readings to predict a feature level power consumption for all features of the network device. The calibration logic then applies a calibration factor to the predicted feature level power consumption and obtains an actual feature level power consumption. Using the actual feature level power consumption, the calibration logic determines an actual power consumption for feature licenses of the network device. The feature and feature license level power consumption is utilized for determining which features or feature licenses can be deactivated when the device power consumption is outside a threshold limit. Such dynamic deactivation ensures that the network device accurately meets the sustainability goals.

This application claims the benefit of U.S. Provisional Patent Application No. 63/589,936, filed Oct. 12, 2023, which is incorporated by reference herein in its entirety.

The present disclosure relates to wireless networking. More particularly, the present disclosure relates to feature level power calibration in network devices.

### BACKGROUND

Network devices, such as routers, switches, and access points, form the backbone of modern communication infrastructures. These devices are essential for facilitating the exchange of data and enabling connectivity across various computer networks, from local area networks (LANs) to wide area networks (WANs). Such network devices include various hardware and software features (e.g., access ports, interfaces, communication protocols, blinking lights, switching mechanisms, security techniques, quality of service, or the like).

In the realm of technological innovation, it is important to discern between features that require high processing and those that do not. Similarly, there is a dichotomy between features or feature sets when it comes to their power consumption. This ties in with the recent movement organizations are taking towards environmental sustainability practices. Environmental sustainability relates to the concept of conserving natural resources, ecosystems, and the environment generally.

Typically, the power consumption is measured exclusively at the device level and corrective measures are implemented when the consumed power exceeds a predefined threshold. However, such a measurement may not be an accurate measurement of the carbon footprint of the network device. Consequently, sustainability practices may not be implemented accurately, leading to increased financial costs. Further, the corrective measures may lead to the deactivation of essential features of the network devices to meet the sustainability goal, thereby affecting the performance and reliability of the network devices.

### SUMMARY OF THE DISCLOSURE

Systems and methods for feature level power calibration in networking devices in accordance with embodiments of the disclosure are described herein. In some embodiments, a device includes a processor, a network interface controller configured to provide access to a network, and a memory communicatively coupled to the processor, wherein the memory includes a calibration logic that is configured to receive a plurality of sensor readings associated with a network device. The network device may be associated with a set of features, and may identify one or more feature permutations associated with the plurality of sensor readings, predict a feature level power consumption for the set of features based on the plurality of sensor readings and the identified one or more feature permutations, apply a calibration factor to the predicted feature level power consumption, and obtain an actual feature level power consumption for the set of features based on an application of the calibration factor to the predicted feature level power consumption.

In some embodiments, a feature permutation of the one or more feature permutations corresponds to a unique subset of features of the set of features.

In some embodiments, at least one of the plurality of sensor readings includes a voltage reading.

In some embodiments, at least one of the plurality of sensor readings includes a current reading.

In some embodiments, the calibration logic is further configured to determine a power consumption of the network device based on one or more sensor readings.

In some embodiments, the calibration logic is further configured to determine, based on the power consumption of the network device, whether the network device is operating within one or more threshold limits.

In some embodiments, the one or more threshold limits are based on at least one sustainability goal set for the network device.

In some embodiments, the one or more threshold limits are dynamically adjustable values.

In some embodiments, the one or more threshold limits are updated based on a user input.

In some embodiments, the calibration logic is further configured to transmit a deactivation signal to the network device in response to determining that the network device is operating outside the one or more threshold limits, the deactivation signal being configured to deactivate one or more features from the set of features.

In some embodiments, the calibration logic is further configured to identify the one or more features to be deactivated based on the actual feature level power consumption of the set of features.

In some embodiments, based on the deactivation of the one or more features, the network device starts operating within the one or more threshold limits.

In some embodiments, the network device is associated with one or more feature licenses.

In some embodiments, a feature license of the one or more feature licenses includes a subset of features from the set of features.

In some embodiments, the calibration logic is further configured to determine, based on the actual feature level power consumption, an actual power consumption of the one or more feature licenses.

In some embodiments, the calibration logic is further configured to determine a power consumption of the network device based on one or more sensor readings.

In some embodiments, the calibration logic is further configured to determine, based on the power consumption of the network device, whether the network device is operating within one or more threshold limits.

In some embodiments, the calibration logic is further configured to transmit a deactivation signal to the network device in response to determining that the network device is operating outside the one or more threshold limits, the deactivation signal being configured to deactivate at least one feature license of the one or more feature licenses.

In some embodiments, a calibration logic is configured to identify one or more feature permutations associated with the plurality of sensor readings, predict a feature level power consumption for the set of features based on the plurality of sensor readings and the identified one or more feature permutations, apply a calibration factor to the predicted feature level power consumption, and obtain an actual feature level power consumption for the set of features based on an application of the calibration factor to the predicted feature level power consumption.

In some embodiments, a method includes receiving a plurality of sensor readings associated with a network device, wherein the network device is associated with a set of features, identifying one or more feature permutations associated with the plurality of sensor readings, predicting a feature level power consumption for the set of features based on the plurality of sensor readings and the identified one or more feature permutations, applying a calibration factor to the predicted feature level power consumption, and obtaining an actual feature level power consumption for the set of features based on an application of the calibration factor to the predicted feature level power consumption.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptional schematic diagram of a networking environment employing feature level power calibration in accordance with various embodiments of the disclosure;

FIG. 2 is a conceptional schematic diagram of a networking environment employing feature license level power calibration in accordance with various embodiments of the disclosure;

FIG. 3 is a conceptional schematic diagram of a networking environment for feature level power calibration in accordance with various embodiments of the disclosure;

FIG. 4 is a conceptual block diagram of a network device in accordance with various embodiments of the disclosure;

FIG. 5 is a flowchart depicting a process for calibrating feature level power consumption in network devices in accordance with various embodiments of the disclosure;

FIG. 6 is a flowchart depicting a process for calibrating feature license level power consumption in network devices in accordance with various embodiments of the disclosure;

FIG. 7 is a flowchart depicting a process for feature level power calibration in network devices in accordance with various embodiments of the disclosure; and

FIG. 8 is a conceptual block diagram of a device suitable for configuration with a calibration logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that determine an actual feature level power consumption in network devices of a network. Network devices, interlined in a network for executing various operations, include various hardware and software features. Examples of these features can include access ports, interfaces, communication protocols, blinking lights, switching mechanisms, security techniques, quality of service, or the like. Features of a network device may be determined (e.g., extracted) based on the current operating state and the configuration of the corresponding network device. Each network device may also include multiple sensors measuring various parameters of the network device and generating sensor readings indicative of the measured parameters. Examples of the sensors may include voltage sensors, current sensors, temperature sensors, or the like.

A network device may be powered by various power source types. Typically, in a network device, the power consumption is measured exclusively at the device level. Such a measurement may not be an accurate measurement of the carbon footprint of the network device. Hence, it is important to accurately determine the power consumed by the network device and various features of the network device, and utilize the power consumption information to allow for a more efficient operation of the network device. A higher level of sustainability can thus be achieved.

To enable accurate measurements of power consumed by the features of a network device, a calibration logic may be implemented. In many embodiments, the calibration logic may be included in each network device to enable the determination of actual power consumption of features of the corresponding network device. In a number of embodiments, the calibration logic may be separate from the network devices. In a variety of embodiments, the calibration logic may be implemented as a part of an infrastructure monitoring device that monitors all network devices of a network.

In some embodiments, the calibration logic may determine feature level power consumption. The calibration logic may receive the sensor readings from the sensors of the network device and identify one or more feature permutations associated with the sensor readings. Based on the sensor readings and the identified one or more feature permutations, the calibration logic may predict the feature level power consumption for all the features. In more embodiments, a feature permutation may correspond to one or more unique features, among all the features of the network device, that are active at a given time instance. Further, the sensor readings at such a time instance may be indicative of the power consumed by the network device at the corresponding time instance. The consumed power is also a factor of which features were activated at the time instance. Thus, the one or more feature permutations may indicate various features that are active at particular time instances, and the power consumption at the corresponding time instances may be indicated by the sensor readings. In additional embodiments, the calibration logic may execute a logistic regression analysis on the sensor readings and the identified one or more feature permutations to predict the power consumed by each feature of the network device.

The calibration logic may also determine at least one calibration factor. In further embodiments, the calibration logic may utilize power values measured across various temperatures, load values, and packet types to determine the calibration factor. The calibration logic may apply the calibration factor to the predicted feature level power consumption and obtain an actual feature level power consumption for the features of the network device. In other words, the power consumption predicted for each feature of a network device is calibrated. In still more embodiments, the calibration factor may be the same or different for each feature. Thus, in the present disclosure, power consumption is measured at the feature level, and the measured power is calibrated to determine the actual feature level power consumption in the network device. This feature level power calibration provides an enhanced way of controlling the power consumption in the network device.

In still further embodiments, the calibration logic may assign a priority level and a power budget to each feature of the network device. The priority level and the power budget may be dynamic and dependent on other features of the network device. Further, the calibration logic may determine a power consumption of the network device based on one or more sensor readings. Based on the power consumption of the network device, the calibration logic may determine whether the network device is operating within one or more threshold limits. In still additional embodiments, the one or more threshold limits may be based on at least one sustainability goal set for the network device. In some more embodiments, the one or more threshold limits may be dynamically adjustable values. In certain embodiments, the one or more threshold limits may be updated based on a user input. If it is determined that the network device is operating outside the one or more threshold limits, one or more features may be deactivated to ensure that the network device starts operating within the one or more threshold limits. The features to be deactivated may be identified based on the actual power consumed by the features, the priority levels of the features, and the power budgets assigned to the features.

In yet more embodiments, each network device may be associated with feature licenses, with each feature license corresponding to one or more features linked together for a particular functionality of the network device. Further, the feature licenses may have financial costs. Hence, it is important to ensure only essential feature licenses are active. In the present disclosure, the calibration logic may determine, based on the actual feature level power consumption, an actual power consumption of the feature licenses. The calibration logic may assign a priority level and a power budget to each feature license. If it is determined that the network device is operating outside the one or more threshold limits, one or more feature licenses may be deactivated to ensure that the network device starts operating within the one or more threshold limits. The feature licenses to be deactivated may be identified based on the actual power consumption of the feature licenses, the priority levels of the feature licenses, and the power budgets assigned to the feature licenses.

Thus, the actual power consumed by each feature can be utilized to ensure that the power consumption of the network device accurately meets the sustainability goals. Further, as relatively less critical features and/or feature licenses are deactivated to bring down the power consumption of the network device, the performance and reliability of the network devices of the present disclosure are higher than conventional network devices where essential features may be deactivated to lower power consumption.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

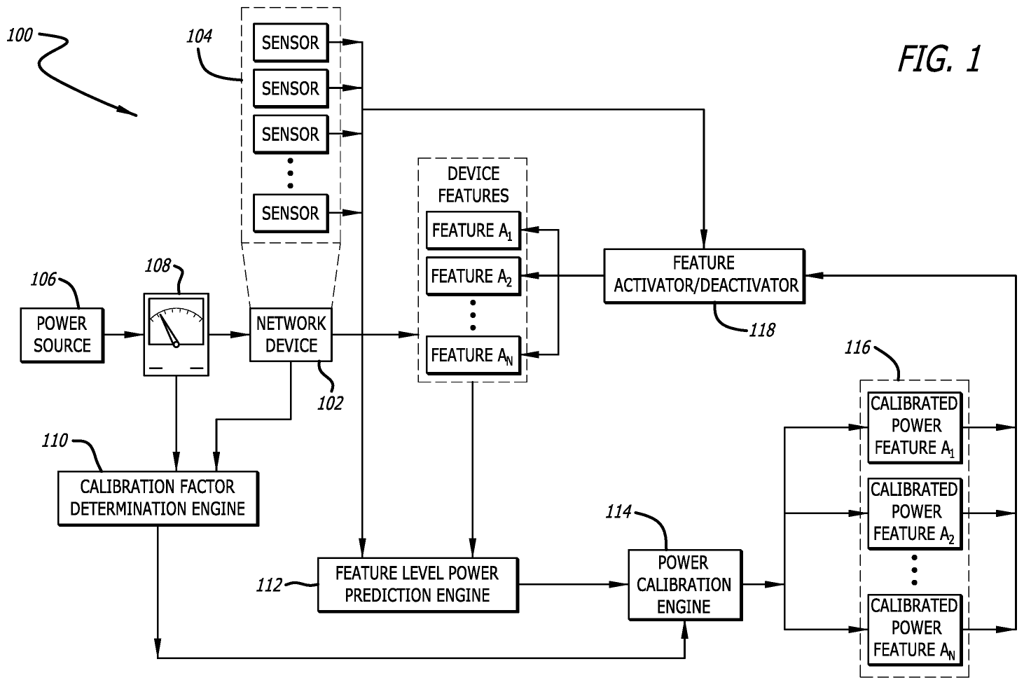

Referring to FIG. 1, a conceptional schematic diagram of a networking environment 100 employing feature level power calibration in accordance with various embodiments of the disclosure is shown. The embodiments depicted in FIG. 1 may show the networking environment 100 which can correspond to a network or a portion of the network.

In many embodiments, the networking environment 100 may include a network device 102. The network device 102 may include hardware and/or software components that facilitate communication and transmission of data between computers or other network-enabled devices. In a network, the network device 102 plays a crucial role in establishing and maintaining connections. Examples of the network device 102 may include a router, a switch, a hub, a modem, an access point, a server, a computing node, or the like.

In a number of embodiments, the network device 102 may include a plurality of sensors 104. As illustrated in FIG. 1, the plurality of sensors 104 may include first through n^{th} sensors 104A-104N. The plurality of sensors 104 may be configured to measure various parameters of the network device 102 and generate a plurality of sensor readings indicative of the measured parameters. For example, the first sensor 104A may be configured to measure a voltage of the network device 102 (e.g., a particular node of the network device 102) and generate a voltage reading (e.g., a sensor reading) indicative of the measured voltage. In such a scenario, the first sensor 104A may correspond to a voltage sensor. Similarly, the second sensor 104B may be configured to measure a current of the network device 102 (e.g., a particular branch of the network device 102) and generate a current reading indicative of the measured current. In such a scenario, the second sensor 104B may correspond to a current sensor. Other examples of the sensor readings may include temperature readings, voltage readings of other nodes of the network device 102, current readings of other nodes of the network device 102, or the like.

In a variety of embodiments, the network device 102 may be associated with a set of features. The set of features may be determined (e.g., extracted) based on the current operating state and the configuration of the network device 102. As illustrated in FIG. 1, the set of features may include first through n^{th} features A₁-A_{N}. Each feature may be a hardware feature, a software feature, or a combination thereof. Examples of the set of features may include access ports, interfaces, communication protocols (e.g., border gateway protocols, internet protocol security, secure shell, or the like), blinking lights, switching mechanisms, security techniques, quality of service, or the like.

In some embodiments, the networking environment 100 may include a power source 106 that may be configured to power the network device 102. The network device 102 may be powered by various power source types. Examples of the power source 106 can include a renewable energy source (e.g., solar cells), an electrical grid, a battery, or the like. The network device 102 may thus be configured to draw power from the power source 106 for its operation. For example, the drawn power may be utilized by the set of features of the network device 102.

Traditionally, network devices have not considered various aspects of operation that can relate to the overall sustainability of the network. For example, devices in communication networks have often used grid-supplied energy as a primary power source. This grid-supplied energy can regularly provide energy that has been generated by a negative environmental impacts-heavy power source such as a coal-powered power plant. However, modern power grids often have more diverse and cleaner energy sources for the provided generated energy. Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes.

The operation of a coal-powered power plant will create a sizeable amount of negative environmental impacts in the form of carbon emissions and the like. Contrast that with a solar array which may not create emissions when generating electricity, but may have negative environmental impacts, such as carbon emission generation, associated with the production and/or disposal of the solar array. Various methods of measuring these negative environmental impacts may occur. One measurement may be to examine the waste products created by the power generated (such as nuclear waste, vs. solar array e-waste, etc.).

It is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” “power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the case of reading.

In order to maximize the overall sustainability of a network, it may be desirable to limit the power use. To that effect, it is important to accurately determine the power consumed by the network device 102 and its features, and utilize the power consumption information to allow for a more efficient operation of the network device 102. In an example, the network device 102 (e.g., a network router) may be operated in a lower power mode or be powered off partially/entirely for a specific period of time or until an event occurs. By utilizing less power during operation, a higher level of sustainability can be achieved.

In additional embodiments, to enable accurate measurements of power consumed by the network device 102 and the set of features, the networking environment 100 may include a power meter 108, a calibration factor determination engine 110, a feature level power prediction engine 112, and a power calibration engine 114.

The power meter 108 may be coupled between the power source 106 and the network device 102. The power meter 108 may be configured to measure the power consumed by the network device 102. The power meter 108 may be a digital meter or an analog meter.

Typically, the measured power is the alternating current (AC) power. Traditionally, measurement methods for power verification are often over simplified or done with a method that achieves inaccurate or highly suspect results, resulting in a lack of consistency and any sense of accuracy or relevance. Further, a product of voltage and current is not an accurate value for measuring power in AC systems. This is the power lost in the systems and is referred to as the apparent power. The real power is what people are charged for (e.g., what the systems consume). The apparent power includes both real power and reactive power, where reactive power is the power that oscillates back and forth between the source and the load without performing any useful work. In such AC systems, a power factor is defined as the ratio of the real power and the apparent power. However, as the actual power is not measured accurately, it is difficult to calculate carbon foot prints and examine operating range trade-offs to correctly size and operate equipment in a specific operating environment. This results in over payment of carbon tax and energy use.

The calibration factor determination engine 110 may be utilized in the networking environment 100 to determine the degree of calibration required in AC systems. The calibration factor determination engine 110 may be coupled to the power meter 108 and the network device 102. The calibration factor determination engine 110 may include suitable circuitry that may be configured to perform one or more operations. For example, the calibration factor determination engine 110 may be configured to determine at least one calibration factor. In still further embodiments, the power factor may be utilized for the calibration factor determination.

To enable the determination of the calibration factor, the calibration factor determination engine 110 may execute various operations. For example, the calibration factor determination engine 110 may be configured to obtain power values measured across various temperatures and load values. For example, the power values may be measured for temperature values of 23° C. (room temperature), 27° C. (acoustic comparative temperature), 35° C., 40° C., 45° C., and 50° C. Similarly, the power values may be measured for idle, 10% load, 30% load, 50% load, 75% load, and full load. The power values may also be measured across packet types associated with the network device 102. In still additional embodiments, the power factor may be utilized for obtaining an efficiency of the power source 106, and thereby enable accurate measurement of power values.

In some more embodiments, the calibration factor determination engine 110 may be configured to create a power table encompassing all the measured power values across various temperatures, load values, and packet types. Using the power table, the calibration factor determination engine 110 may be configured to determine the minimum power across all power values, the maximum power across all power values, the typical value of the power sum, and the power sum average. The power sum average corresponds to the sum of all power values divided by the number of power values. The typical value of the power sum corresponds to the sum of idle, 10% load, 30% load, and 50% load power values using two particular packet types (e.g., md data/md size 64 b to 9220 b and md data/md size 64 b to 1518 b) for temperatures of 23° C., 27° C., and 35° C., divided by the number of these power values. The typical value of the power sum can be used in determining the carbon footprint and carbon tax.

In certain embodiments, the calibration factor determination engine 110 may be configured to obtain the power of a power source (such as the power source 106). Additionally, the calibration factor determination engine 110 may be configured to determine the best data rate, the best operating temperature, and the best packet type for the network device 102. Using the created power table and other information described above, the calibration factor determination engine 110 may be configured to determine the real consumed power. Based on the measured power and the determined power, the calibration factor determination engine 110 may be configured to determine the actual power. The actual power may be a mean value of the measured power and the determined power. The inaccurately measured power can thus be calibrated. The measured power and the actual power can be utilized to determine the calibration factor. In yet more embodiments, the calibration factor may be implemented at the device level (e.g., similarly applicable for all features of the network device 102). In still yet more embodiments, the calibration factor may be dynamically adjusted for each feature of the network device 102. In many further embodiments, the same calibration factor may be utilized for some features, whereas, for remaining features, different calibration factors may be utilized.

In many additional embodiments, the feature level power prediction engine 112 may be utilized in the networking environment 100 to determine feature level power consumption. The feature level power prediction engine 112 may be coupled to the plurality of sensors 104. The feature level power prediction engine 112 may include suitable circuitry that may be configured to perform one or more operations. For example, the feature level power prediction engine 112 may be configured to receive the plurality of sensor readings from the plurality of sensors 104. The feature level power prediction engine 112 may be configured to identify one or more feature permutations associated with the plurality of sensor readings. Based on the plurality of sensor readings and the identified one or more feature permutations, the feature level power prediction engine 112 may be configured to predict a feature level power consumption for the set of features. In other words, the feature level power prediction engine 112 may predict the power consumed by each of the first through n^{th} features A₁-A_{N}.

In still yet further embodiments, a feature permutation may correspond to a unique subset of features, of the set of features, that are active at a given time instance. Further, the plurality of sensor readings at such a time instance may be indicative of the power consumed by the network device 102 at the corresponding time instance. The consumed power is also a factor of which features were activated at the time instance. Thus, the one or more feature permutations may indicate various features that are active at particular time instances, and the power consumption at the corresponding time instances may be indicated by the plurality of sensor readings. The feature level power prediction engine 112 may correspond to a logistic regression model that may be configured to execute a logistic regression analysis on the plurality of sensor readings and the identified one or more feature permutations to predict the power consumed by each feature of the network device 102.

In still yet additional embodiments, the logistic regression model may be trained by activating and deactivating each feature over time and measuring the impact one or more features have on each sensor reading. After the logistic regression model is trained, the feature contribution is determined by evaluating the positive and negative impact that each available feature has for each particular sensor. For features that can be correlated to have an impact against the sensor readings, features are iteratively enabled and disabled to predict the impact that sensor readings would reflect based on feature usage. The collected range of sensor reading values is then collated to create a range of values based on the presence or absence of a feature across the network device 102. Further, the plurality of sensor readings and the associated features may be utilized to determine the power consumption for each feature. In several embodiments, a feature to power mapping model may be utilized to determine the power consumption for each feature.

The power calibration engine 114 may be utilized in the networking environment 100 to execute feature level power calibration. The power calibration engine 114 may be coupled to the feature level power prediction engine 112 and the calibration factor determination engine 110. The power calibration engine 114 may include suitable circuitry that may be configured to perform one or more operations. For example, the power calibration engine 114 may be configured to receive the predicted power consumption for each of the first through n^{th} features A₁-A_{N} from the feature level power prediction engine 112, and the calibration factor from the calibration factor determination engine 110. The power calibration engine 114 may be configured to apply the calibration factor to the predicted feature level power consumption and obtain an actual feature level power consumption for the set of features (e.g., the first through n^{th} features A₁-A_{N}) based on the application of the calibration factor to the predicted feature level power consumption. Thus, the power calibration engine 114 may generate the calibrated power consumption for the first through n^{th} features A₁-A_{N} (illustrated in dotted boxes 116 in FIG. 1). In an example, the power consumption for the border gateway protocol may be predicted to be 0.561 Watts (W), whereas, after calibration, the power consumption for the border gateway protocol may be 0.713 W. In several more embodiments, the calibration factor applied for each feature may be the same. In numerous embodiments, a different calibration factor can be applied for each feature. In numerous additional embodiments, the same calibration factor may be applied for some features, and different calibration factors may be applied for the remaining features.

In further additional embodiments, the sensor readings may include inaccuracies which may to lead inaccuracies in the power consumption predicted for the set of features. Hence, in the present disclosure, the predicted power consumption is calibrated (e.g., adjusted) using the calibration factor to remove the inaccuracies in the power measurement, and in turn, determine the actual power consumed by each feature of the set of features.

The calibrated power can be utilized for controlling various operations of the network device 102. The networking environment 100 may include a feature activator/deactivator 118 that may be configured to control the activation/deactivation of the set of features. The feature activator/deactivator 118 may be coupled to the power calibration engine 114 and the network device 102 (e.g., the plurality of sensors 104). The feature activator/deactivator 118 may include suitable circuitry that may be configured to perform one or more operations. For example, the feature activator/deactivator 118 may be configured to receive the actual feature level power consumption for the set of features from the power calibration engine 114. The feature activator/deactivator 118 may be configured to assign a priority level and a power budget to each feature of the set of features. The priority level and the power budget may be dynamic and dependent on other features of the network device 102. Features that generally utilize higher levels of power may be classified as “run the business” and impactful to the mission of the organization. Features that are more sporadic in energy usage and those that use less energy, or express seasonality may be given a lower priority based on the infrequency of usage.

The feature activator/deactivator 118 may be configured to receive the plurality of sensor readings from the plurality of sensors 104. The feature activator/deactivator 118 may be configured to determine a power consumption of the network device 102. The power consumption of the network device 102 may be determined based on one or more sensor readings of the plurality of sensor readings. Based on the power consumption of the network device 102, the feature activator/deactivator 118 may be configured to determine whether the network device 102 is operating within one or more threshold limits. In more embodiments, the one or more threshold limits are based on at least one sustainability goal set for the network device 102. In further embodiments, the one or more threshold limits are dynamically adjustable values. In still more embodiments, the one or more threshold limits are updated based on a user input.

If the feature activator/deactivator 118 determines that the network device 102 is operating within the one or more threshold limits, no action is taken and all the active features may continue to remain active. Conversely, if the feature activator/deactivator 118 determines that the network device 102 is operating outside the one or more threshold limits, one or more operations may be executed to ensure that the network device 102 is operating within the one or more threshold limits. For example, the feature activator/deactivator 118 may be configured to identify one or more features, of the set of features, that are to be deactivated. The feature activator/deactivator 118 may identify the one or more features to be deactivated based on the actual power consumption of the set of features, the priority levels of the set of features, and the power budgets of the set of features. In many examples, the lower priority features consuming more than half of the corresponding power budgets may be identified for deactivation.

In response to determining that the network device 102 is operating outside the one or more threshold limits, the feature activator/deactivator 118 may be configured to transmit a deactivation signal to the network device 102. The deactivation signal may be configured to deactivate the identified one or more features from the set of features. Based on the deactivation of the one or more features, the network device 102 may start operating within the one or more threshold limits. Thus, the actual power consumed by each feature of the set of features can be utilized to ensure that the power consumption of the network device 102 accurately meets the sustainability goals. Further, as relatively less critical features are deactivated to bring down the power consumption of the network device 102, the performance and reliability of the network devices of the present disclosure are higher than conventional network devices where essential features may be deactivated to lower power consumption.

The calibration factor determination engine 110, the feature level power prediction engine 112, the power calibration engine 114, the feature activator/deactivator 118, or a combination thereof may be referred to as a calibration logic that may be configured to facilitate feature level power calibration in the network device 102.

In FIG. 1, the networking environment 100 is shown to include a single network device to keep the illustration concise and clear and should not be considered a limitation of the disclosure. The networking environment 100 may include more than one network device and the feature level power calibration may be implemented in each network device in the similar manner described above. To enable such an operation, the networking environment 100 may include an infrastructure monitoring device that may be coupled to all the network devices of the networking environment 100, and may be configured to monitor and control the operations of all the network devices.

The networking environment 100 depicted in FIG. 1 is shown as a simplified, conceptual networking environment. Those skilled in the art will understand that a networking environment 100 can include a large variety of devices and be arranged in a virtually limitless number of combinations based on the desired application and available deployment environment.

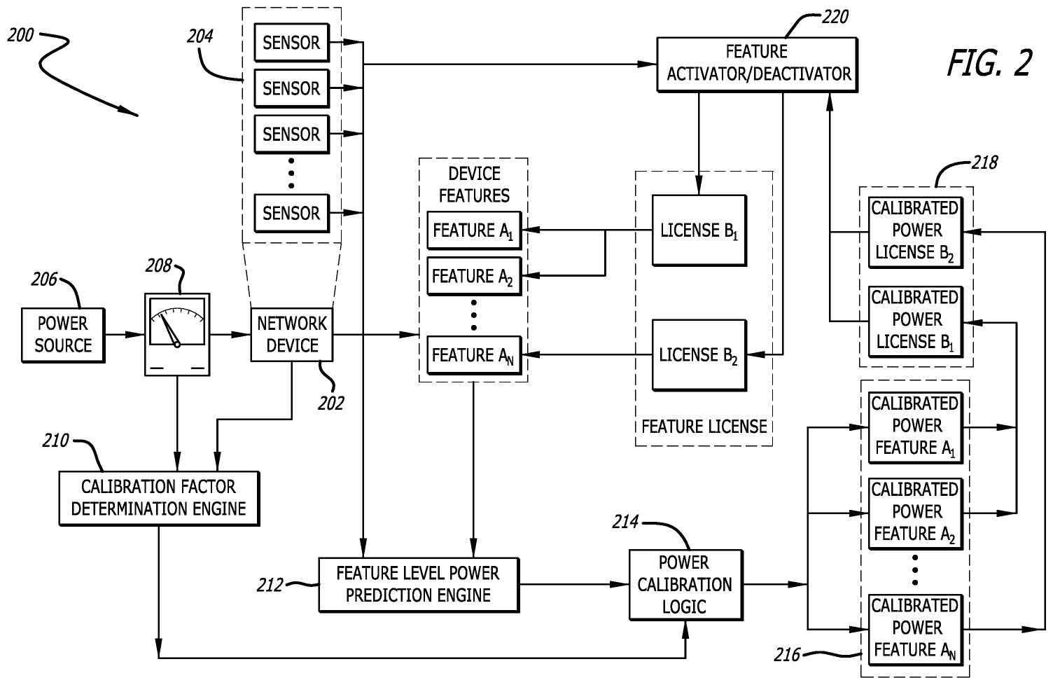

Although a specific embodiment for a feature level power calibration being utilized for feature activation/deactivation suitable for carrying out the various steps, processes, methods, and operations described herein is discussed with respect to FIG. 1, any of a variety of systems and/or processes may be utilized in accordance with embodiments of the disclosure. For example, the actual power consumption of the set of features may be utilized for managing feature licenses associated with the set of features. The elements depicted in FIG. 1 may also be interchangeable with other elements of FIGS. 2-8 as required to realize a particularly desired embodiment.

Referring to FIG. 2, a conceptional schematic diagram of a networking environment 200 employing feature license level power calibration in accordance with various embodiments of the disclosure is shown.

In many embodiments, the networking environment 200 may include a network device 202. The network device 202 may include a plurality of sensors 204. As illustrated in FIG. 2, the plurality of sensors 204 may include first through n^{th} sensors 204A-204B. The plurality of sensors 204 may be configured to measure various parameters of the network device 202 and generate a plurality of sensor readings indicative of the measured parameters. Examples of the sensor readings may include temperature readings, voltage readings of various nodes of the network device 202, current readings of various nodes of the network device 202, or the like. The network device 202 may be associated with a set of features. As illustrated in FIG. 2, the set of features may include first through n^{th} features A₁-A_{N}.

In a number of embodiments, the networking environment 200 may include a power source 206 may be configured to power the network device 202. The network device 202 may thus be configured to draw power from the power source 206 for its operation. The drawn power may be utilized by the set of features of the network device 202. In order to maximize the overall sustainability of a network, it may be desirable to limit the power use. To that effect, it is important to accurately determine the power consumed by the network device 202 and its features, and utilize the power consumption information to allow for a more efficient operation of the network device 202.

In a variety of embodiments, to enable accurate measurements of power consumed by the network device 202 and the set of features, the networking environment 200 may include a power meter 208, a calibration factor determination engine 210, a feature level power prediction engine 212, and a power calibration engine 214.

The power meter 208 may be coupled between the power source 206 and the network device 202. The power meter 208 may be configured to measure the power consumed by the network device 202. The calibration factor determination engine 210 may be coupled to the power meter 208 and the network device 202. The calibration factor determination engine 210 may include suitable circuitry that may be configured to perform one or more operations. For example, the calibration factor determination engine 210 may be configured to determine at least one calibration factor (as described in the foregoing description of FIG. 1).

The feature level power prediction engine 212 may be utilized in the networking environment 200 to determine feature level power consumption. The feature level power prediction engine 212 may be coupled to the plurality of sensors 204. The feature level power prediction engine 212 may include suitable circuitry that may be configured to perform one or more operations. For example, the feature level power prediction engine 212 may be configured to receive the plurality of sensor readings from the plurality of sensors 204 and identify one or more feature permutations associated with the plurality of sensor readings. Based on the plurality of sensor readings and the identified one or more feature permutations, the feature level power prediction engine 212 may be configured to predict a feature level power consumption for the set of features. In other words, the feature level power prediction engine 212 may predict the power consumed by each of the first through n^{th} features A₁-A_{N}.

The power calibration engine 214 may be utilized in the networking environment 200 to execute feature level power calibration. The power calibration engine 214 may be coupled to the feature level power prediction engine 212 and the calibration factor determination engine 210. The power calibration engine 214 may include suitable circuitry that may be configured to perform one or more operations. For example, the power calibration engine 214 may be configured to receive the predicted feature level power consumption for the set of features from the feature level power prediction engine 212, and the calibration factor from the calibration factor determination engine 210. The power calibration engine 214 may be configured to apply the calibration factor to the predicted feature level power consumption and obtain an actual feature level power consumption for the set of features (e.g., the first through n^{th} features A₁-A_{N}) based on the application of the calibration factor to the predicted feature level power consumption. Thus, the power calibration engine 214 may generate the calibrated power consumption for the first through n^{th} features A₁-A_{N} (illustrated in dotted boxes 216 in FIG. 2).

The calibrated power can be utilized for controlling various operations of the network device 202. In some embodiments, the network device 202 can be associated with a set of feature licenses. As illustrated in FIG. 2, the set of feature licenses may include first and second feature licenses B₁ and B₂. Each feature license may include one or more features, of the set of features, linked together for a particular functionality of the network device 202. For example, the first and second features A₁ and A₂ may be linked together to form the first feature license B₁, whereas the n^{th} feature Ax may be associated with the second feature license B₂. The set of feature licenses may have financial costs associated with the functionality of the network device 202.

In more embodiments, the power calibration engine 214 may be configured to determine, based on the actual feature level power consumption of the set of features, an actual power consumption of the set of feature licenses. In other words, the power calibration engine 214 may be configured to generate the calibrated power consumption for the first and second feature licenses B₁ and B₂ (illustrated in dotted boxes 218 in FIG. 2). In additional embodiments, the calibrated power consumption for the first feature license Bi may be equal to the sum of the calibrated power consumption of the first and second features A₁ and A₂. Similarly, the calibrated power consumption for the second feature license B₂ may be equal to the calibrated power consumption of the n^{th} feature A_{N}.

In further embodiments, the networking environment 200 may include a license activator/deactivator 220 that may be configured to control the activation/deactivation of the set of feature licenses. The license activator/deactivator 220 may be coupled to the power calibration engine 214 and the network device 202 (e.g., the plurality of sensors 204). The license activator/deactivator 220 may include suitable circuitry that may be configured to perform one or more operations. For example, the license activator/deactivator 220 may be configured to receive the actual feature level power consumption for the set of feature licenses from the power calibration engine 214. The license activator/deactivator 220 may be configured to assign a priority level and a power budget to each feature license of the set of feature licenses.

In still more embodiments, the license activator/deactivator 220 may be configured to receive the plurality of sensor readings from the plurality of sensors 204. The license activator/deactivator 220 may be configured to determine a power consumption of the network device 202. The power consumption of the network device 202 may be determined based on one or more sensor readings of the plurality of sensor readings. Based on the power consumption of the network device 202, the license activator/deactivator 220 may be configured to determine whether the network device 202 is operating within the one or more threshold limits.

If the license activator/deactivator 220 determines that the network device 202 is operating within the one or more threshold limits, no action is taken and all the active feature licenses may continue to remain active. Conversely, if the license activator/deactivator 220 determines that the network device 202 is operating outside the one or more threshold limits, one or more operations may be executed to ensure that the network device 202 is operating within the one or more threshold limits. For example, the license activator/deactivator 220 may be configured to identify one or more feature licenses, of the set of feature licenses, to be deactivated. The license activator/deactivator 220 may identify the one or more feature licenses to be deactivated based on the actual power consumption of the set of feature licenses, the priority levels assigned to the set of feature licenses, and the power budgets assigned to the set of feature licenses.

In still further embodiments, in response to determining that the network device 202 is operating outside the one or more threshold limits, the license activator/deactivator 220 may be configured to transmit a deactivation signal to the network device 202. The deactivation signal may be configured to deactivate the identified one or more feature licenses from the set of feature licenses. Based on the deactivation of the one or more feature licenses, the network device 202 may start operating within the one or more threshold limits. Thus, the actual power consumed by each feature license of the set of feature licenses can be utilized to ensure that the power consumption of the network device 102 accurately meets the sustainability goals. Further, as relatively less critical feature licenses are deactivated to bring down the power consumption of the network device 202, the performance and reliability of the network devices of the present disclosure are higher than conventional network devices where essential features may be deactivated to lower power consumption.

Although a specific embodiment for a feature license level power calibration in network devices suitable for carrying out the various steps, processes, methods, and operations described herein is discussed with respect to FIG. 1, any of a variety of systems and/or processes may be utilized in accordance with embodiments of the disclosure. For example, the feature level or feature license power calibration may be implemented for various other devices, such as mobile devices, computing devices, or the like. The elements depicted in FIG. 2 may also be interchangeable with other elements of FIGS. 1 and 3-8 as required to realize a particularly desired embodiment.

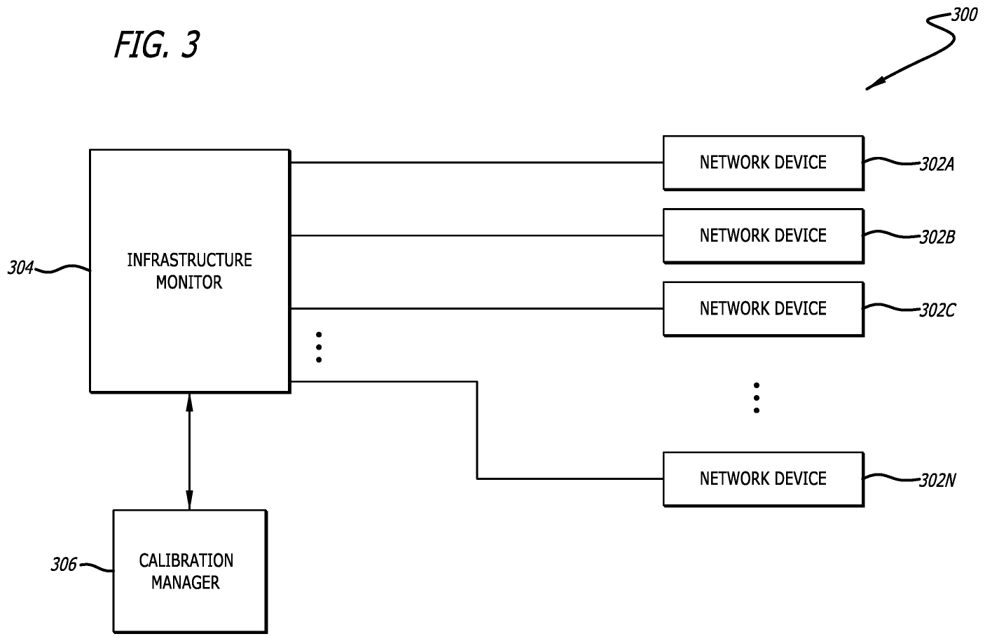

Referring to FIG. 3, a conceptional schematic diagram of a networking environment 300 for feature level power calibration in accordance with various embodiments of the disclosure is shown. The embodiments depicted in FIG. 3 may show the networking environment 300 to include a plurality of network devices 302A-302N, an infrastructure monitoring device 304, and a calibration manager 306.

A network device 302i, wherein subscript “i” indicates that this network device may be any of the plurality of network devices 302A-302N, may include a plurality of sensors (not shown) that may be configured to measure various parameters of the network device 302i and generate a plurality of sensor readings indicative of the measured parameters. Examples of the sensor readings may include temperature readings, voltage readings of various nodes of the network device 302i, current readings of various nodes of the network device 302i, or the like. The network device 302i may be associated with a set of features and a set of feature licenses. Each feature license may include one or more features.

In many embodiments, the infrastructure monitoring device 304 may be coupled to the plurality of network devices 302A-302N, and may be configured to monitor and/or control the plurality of network devices 302A-302N. For example, the infrastructure monitoring device 304 may be configured to obtain the plurality of sensor readings from the network device 302i and provide the obtained plurality of sensor readings to the calibration manager 306. In a number of embodiments, the infrastructure monitoring device 304 may be configured to activate/deactivate one or more features or feature licenses of the network device 302i to control the power consumption of the network device 302i. This ensures that all the network devices (e.g., the plurality of network devices 302A-302N) of the networking environment 300 adhere to the sustainability goals of the networking environment 300.

The calibration manager 306 may be configured to identify one or more feature permutations associated with the plurality of sensor readings of the network device 302i. Based on the plurality of sensor readings and the identified one or more feature permutations, the calibration manager 306 may be configured to predict a feature level power consumption for the set of features. In a variety of embodiments, the calibration manager 306 may be configured to determine at least one calibration factor (as described in the foregoing description of FIG. 1) for the network device 302i. The calibration manager 306 may be configured to apply the calibration factor to the predicted feature level power consumption and obtain an actual feature level power consumption for the set of features. Based on the actual feature level power consumption for the set of features, the calibration manager 306 may be configured to determine the actual power consumption for the set of feature licenses. The calibrated power can be utilized for controlling various operations of each network device.

The calibration manager 306 may be configured to assign a priority level and a power budget to each feature and each feature license of the network device 302i. In some embodiments, the calibration manager 306 may be configured to determine a power consumption of the network device 302i and determine whether the network device 302i is operating within one or more threshold limits. If the calibration manager 306 determines that the network device 302i is operating within the one or more threshold limits, no action is taken and all the active features and feature licenses may continue to remain active. Conversely, if the calibration manager 306 determines that the network device 302i is operating outside the one or more threshold limits, one or more operations may be executed to ensure that the network device 302i is operating within the one or more threshold limits. For example, the calibration manager 306 may be configured to identify one or more features or one or more feature licenses that are to be deactivated to bring the power consumption of the network device 302i back within the or more threshold limits. The calibration manager 306 may identify the one or more features to be deactivated based on the actual power consumption of the set of features, the priority levels of the set of features, and the power budgets of the set of features. Similarly, the calibration manager 306 may identify the one or more feature licenses to be deactivated based on the actual power consumption of the set of feature licenses, the priority levels of the set of feature licenses, and the power budgets of the set of feature licenses.

In response to determining that the network device 302i is operating outside the one or more threshold limits, the calibration manager 306 may be configured to transmit a deactivation signal to the network device 302i via the infrastructure monitoring device 304. The deactivation signal may be configured to deactivate the identified one or more features or feature licenses. Thus, the feature level power calibration can be utilized to ensure that the power consumption of network devices accurately meets the sustainability goals.

Although a specific embodiment for the calibration manager 306 and the infrastructure monitoring device 304 being separate entities suitable for carrying out the various steps, processes, methods, and operations described herein is discussed with respect to FIG. 3, any of a variety of systems and/or processes may be utilized in accordance with embodiments of the disclosure. For example, the calibration manager 306 may be included in the infrastructure monitoring device 304. In numerous embodiments, the calibration manager 306 may be included in a network device of the plurality of network devices 302A-302N. The elements depicted in FIG. 3 may also be interchangeable with other elements of FIGS. 1, 2, and 4-8 as required to realize a particularly desired embodiment.

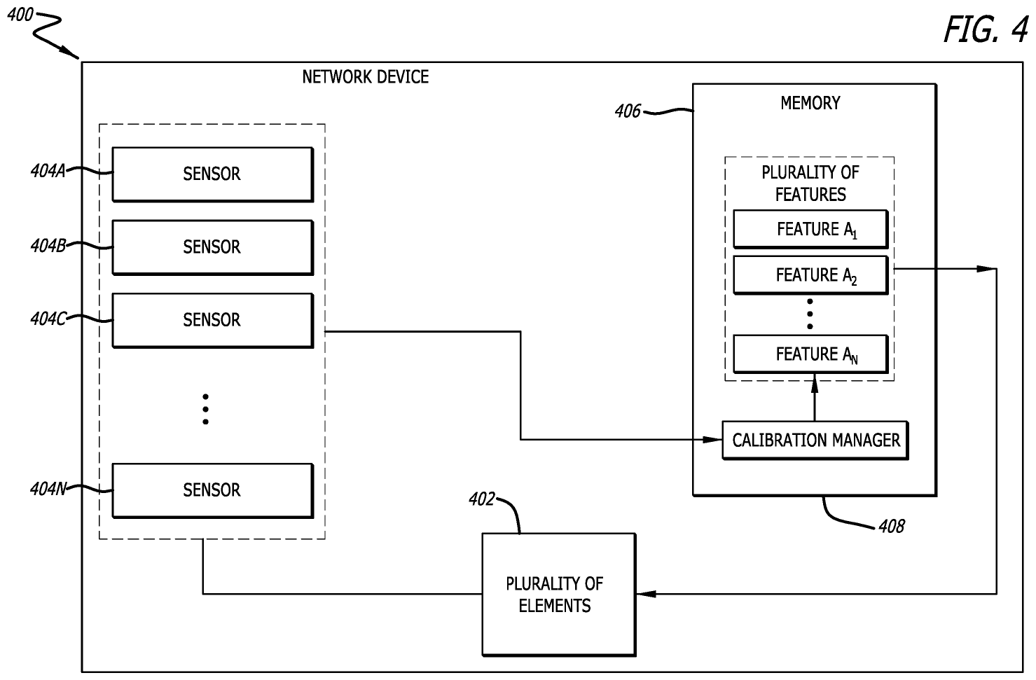

Referring to FIG. 4, a schematic block diagram of a network device 400 in accordance with various embodiments of the disclosure is shown. The embodiments depicted in FIG. 4 may show the network device 400 to include a plurality of elements 402, a plurality of sensors 404A-404N, and a memory 406.

The plurality of elements 402 may correspond to various hardware elements of the network device 400. Examples of the hardware elements may include Ethernet ports, network controllers, security processors, indicators, or the like. The plurality of sensors 404A-404N may be configured to measure various parameters of the network device 400 and generate a plurality of sensor readings indicative of the measured parameters. The network device 400 may be associated with a set of features and a set of feature licenses. Each feature license may include one or more features. The memory 406 may include a calibration manager 408. The memory 406 may be configured to store a set of features associated with the network device 400. Although not shown, the memory 406 may be configured to store a set of feature licenses associated with the network device 400.

The calibration manager 408 may be configured to identify one or more feature permutations associated with the plurality of sensor readings of the network device 400. Based on the plurality of sensor readings and the identified one or more feature permutations, the calibration manager 408 may be configured to predict a feature level power consumption for the set of features. In a variety of embodiments, the calibration manager 408 may be configured to determine at least one calibration factor (as described in the foregoing description of FIG. 1) for the network device 400. The calibration manager 408 may be configured to apply the calibration factor to the predicted feature level power consumption and obtain an actual feature level power consumption for the set of features. Based on the actual feature level power consumption for the set of features, the calibration manager 408 may be configured to determine the actual power consumption for the set of feature licenses. The calibrated power can be utilized for controlling various operations of each network device.

The calibration manager 408 may be configured to assign a priority level and a power budget to each feature and each feature license of the network device 400. In some embodiments, the calibration manager 408 may be configured to determine a power consumption of the network device 400 and determine whether the network device 400 is operating within one or more threshold limits. If the calibration manager 408 determines that the network device 400 is operating within the one or more threshold limits, no action is taken and all the active features and feature licenses may continue to remain active. Conversely, if the calibration manager 408 determines that the network device 302i is operating outside the one or more threshold limits, one or more operations may be executed to ensure that the network device 400 is operating within the one or more threshold limits. For example, the calibration manager 408 may be configured to identify one or more features or one or more feature licenses that are to be deactivated to bring the power consumption of the network device 400 back within the or more threshold limits. The calibration manager 408 may identify the one or more features to be deactivated based on the actual power consumption of the set of features, the priority levels of the set of features, and the power budgets of the set of features. Similarly, the calibration manager 408 may identify the one or more feature licenses to be deactivated based on the actual power consumption of the set of feature licenses, the priority levels of the set of feature licenses, and the power budgets of the set of feature licenses.

In response to determining that the network device 400 is operating outside the one or more threshold limits, the calibration manager 408 may be configured to transmit a deactivation signal to the network device 400. The deactivation signal may be configured to deactivate the identified one or more features or feature licenses. Thus, the feature level power calibration can be utilized to ensure that the power consumption of network devices accurately meets the sustainability goals.

Although a specific embodiment for the calibration manager 408 being included in a network device (e.g., the network device 400) suitable for carrying out the various steps, processes, methods, and operations described herein is discussed with respect to FIG. 4, any of a variety of systems and/or processes may be utilized in accordance with embodiments of the disclosure. For example, the calibration manager 408 may be configured to periodically correct the calibration factor to accommodate changes in the network device 400 over time. In further additional embodiments, a network device may include a single sensor. The elements depicted in FIG. 4 may also be interchangeable with other elements of FIGS. 1-3 and 5-8 as required to realize a particularly desired embodiment.

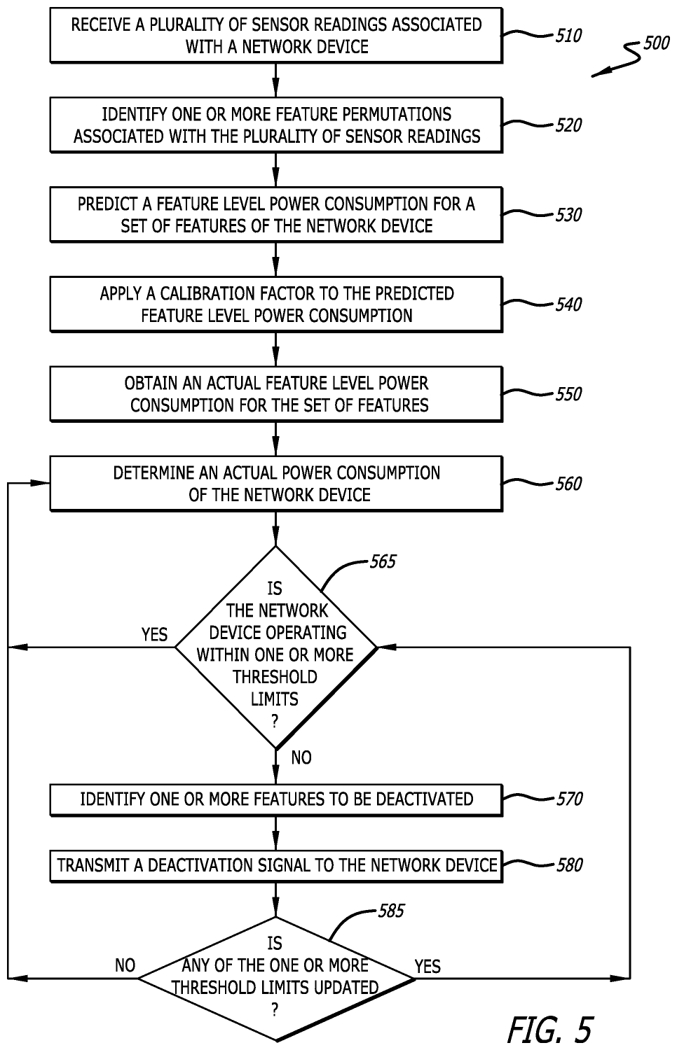

Referring to FIG. 5, a process 500 for calibrating feature level power consumption in network devices in accordance with various embodiments of the disclosure is shown. In many embodiments, the process 500 may receive a plurality of sensor readings associated with a network device (block 510). A plurality of sensors of the network device may be configured to measure various parameters of the network device and generate the plurality of sensor readings indicative of the measured parameters. The network device may be associated with a set of features. The set of features may be determined (e.g., extracted) based on the current operating state and the configuration of the network device. Each feature may be a hardware feature, a software feature, or a combination thereof.

In a number of embodiments, the process 500 may identify one or more feature permutations associated with the plurality of sensor readings (block 520). In a variety of embodiments, the process 500 may predict a feature level power consumption for the set of features of the network device based on the plurality of sensor readings and the identified one or more feature permutations (block 530). A feature permutation may correspond to a unique subset of features, of the set of features, that are active at a given time instance. Further, the plurality of sensor readings at such a time instance may be indicative of the power consumed by the network device at the corresponding time instance. The consumed power is also a factor of which features were activated at the time instance. Thus, the one or more feature permutations may indicate various features that are active at particular time instances, and the power consumption at the corresponding time instances may be indicated by the plurality of sensor readings. In some embodiments, a logistic regression analysis is executed on the plurality of sensor readings and the identified one or more feature permutations to predict the power consumed by each feature of the network device.

In more embodiments, the process 500 may apply a calibration factor to the predicted feature level power consumption (block 540). In additional embodiments, the process 500 may obtain an actual feature level power consumption for the set of features based on the application of the calibration factor to the predicted feature level power consumption (block 550). In an example, the power consumption for the border gateway protocol may be predicted to be 0.561 W, whereas, after calibration, the power consumption for the border gateway protocol may be 0.713 W. In further embodiments, the calibration factor applied for each feature may be the same. In still more embodiments, a different calibration factor can be applied for each feature. In still further embodiments, the same calibration factor may be applied for some features and different calibration factors may be applied for the remaining features.

Thus, the actual power consumed by each feature of the set of features can be determined. The calibrated power can be utilized for controlling various operations of the network device. In still additional embodiments, the process 500 may determine a power consumption of the network device (block 560). The power consumption of the network device may be determined based on one or more sensor readings of the plurality of sensor readings. A priority level and a power budget may be assigned to each feature of the set of features.

In some more embodiments, the process 500 can determine if the network device is operating within one or more threshold limits (block 565). In certain embodiments, the one or more threshold limits may be based on at least one sustainability goal set for the network device. In yet more embodiments, the one or more threshold limits may be dynamically adjustable values. In still yet more embodiments, the one or more threshold limits are updated based on a user input.

In many further embodiments, in response to the network device operating within the one or more threshold limits, the process 500 may determine the power consumption of the network device in a loop until the network device operates outside the one or more threshold limits. However, in many additional embodiments, in response to the network device operating outside the one or more threshold limits, the process 500 may identify one or more features to be deactivated (block 570). The one or more features to be deactivated are identified based on the actual power consumption of the set of features, the priority levels of the set of features, and the power budgets of the set of features. In many examples, the lower priority features consuming more than half of the corresponding power budgets may be identified for deactivation.

In still yet further embodiments, the process 500 may transmit a deactivation signal to the network device (block 580). The deactivation signal may be configured to deactivate the identified one or more features from the set of features. Based on the deactivation of the one or more features, the network device may start operating within the one or more threshold limits.

In still yet additional embodiments, the process 500 may determine if any of the one or more threshold limits are updated (block 585). In several embodiments, in response to none of the threshold limits being updated, the process 500 may determine the power consumption of the network device in a loop until the network device operates outside the one or more threshold limits. However, in several more embodiments, in response to at least one of the threshold limits being updated, the process 500 can determine if the network device is operating within one or more threshold limits.

Although a specific embodiment for a feature level power calibration being utilized for feature activation/deactivation suitable for carrying out the various steps, processes, methods, and operations described herein is discussed with respect to FIG. 5, any of a variety of systems and/or processes may be utilized in accordance with embodiments of the disclosure. For example, the actual power consumption of the set of features may be utilized for managing feature licenses associated with the set of features. The elements depicted in FIG. 5 may also be interchangeable with other elements of FIGS. 1-4 and 6-8 as required to realize a particularly desired embodiment.

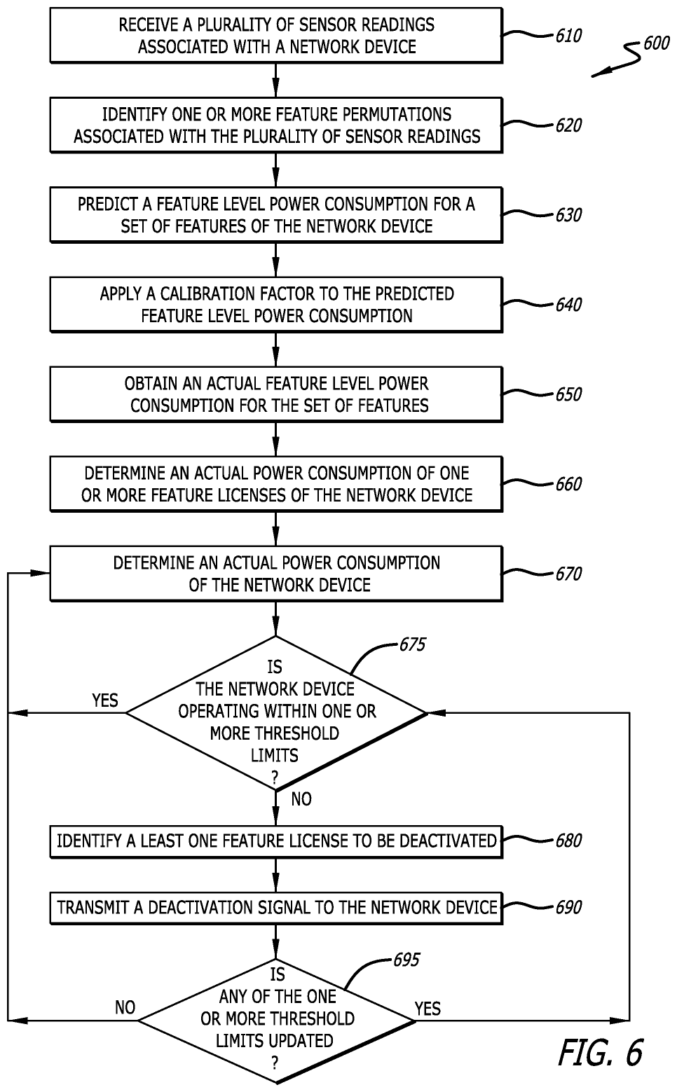

Referring to FIG. 6, a process 600 for calibrating feature license level power consumption in network devices in accordance with various embodiments of the disclosure is shown. In many embodiments, the process 600 may receive a plurality of sensor readings associated with a network device (block 610). A plurality of sensors of the network device may be configured to measure various parameters of the network device and generate the plurality of sensor readings indicative of the measured parameters. The network device may be associated with a set of features. The set of features may be determined (e.g., extracted) based on the current operating state and the configuration of the network device. The network device may be associated with a set of feature licenses. A feature license may include one or more features.

In a number of embodiments, the process 600 may identify one or more feature permutations associated with the plurality of sensor readings (block 620). In a variety of embodiments, the process 600 may predict a feature level power consumption for the set of features of the network device based on the plurality of sensor readings and the identified one or more feature permutations (block 630). A feature permutation may correspond to a unique subset of features, of the set of features, that are active at a given time instance. In some embodiments, a logistic regression analysis is executed on the plurality of sensor readings and the identified one or more feature permutations to predict the power consumed by each feature of the network device.

In more embodiments, the process 600 may apply a calibration factor to the predicted feature level power consumption (block 640). In additional embodiments, the process 600 may obtain an actual feature level power consumption for the set of features based on the application of the calibration factor to the predicted feature level power consumption (block 650). In further embodiments, the calibration factor applied for each feature may be the same. In still more embodiments, a different calibration factor can be applied for each feature. In still further embodiments, the same calibration factor may be applied for some features and different calibration factors may be applied for the remaining features.

In further additional embodiments, the process 600 may obtain an actual power consumption of the set of feature licenses (block 660). In many examples, if a feature license includes multiple features, the calibrated power consumption for the feature license may be equal to the sum of the calibrated power consumption of the associated features. In several examples, if a feature license includes a single feature, the calibrated power consumption for the feature license may be equal to the calibrated power consumption of the associated feature.

Thus, the actual power consumed by each feature license of the set of feature licenses can be determined. The calibrated power can be utilized for controlling various operations of the network device. In still additional embodiments, the process 600 may determine a power consumption of the network device (block 670). The power consumption of the network device may be determined based on one or more sensor readings of the plurality of sensor readings. A priority level and a power budget may be assigned to each feature of the set of features.

In some more embodiments, the process 600 can determine if the network device is operating within one or more threshold limits (block 675). In certain embodiments, the one or more threshold limits may be based on at least one sustainability goal set for the network device. In yet more embodiments, the one or more threshold limits may be dynamically adjustable values. In still yet more embodiments, the one or more threshold limits are updated based on a user input.

In many further embodiments, in response to the network device operating within the one or more threshold limits, the process 600 may determine the power consumption of the network device in a loop until the network device operates outside the one or more threshold limits. However, in many additional embodiments, in response to the network device operating outside the one or more threshold limits, the process 600 may identify at least one feature license to be deactivated (block 680). The feature license to be deactivated may be identified based on the actual power consumption of the set of feature licenses, the priority levels of the set of feature licenses, and the power budgets of the set of feature licenses.

In still yet further embodiments, the process 600 may transmit a deactivation signal to the network device (block 690). The deactivation signal may be configured to deactivate the identified feature license. Based on the deactivation of the feature license, the network device may start operating within the one or more threshold limits.

In still yet additional embodiments, the process 600 may determine if any of the one or more threshold limits are updated (block 695). In several embodiments, in response to none of the threshold limits being updated, the process 600 may determine the power consumption of the network device in a loop until the network device operates outside the one or more threshold limits. However, in several more embodiments, in response to at least one of the threshold limits being updated, the process 600 can determine if the network device is operating within one or more threshold limits.

Although a specific embodiment for a feature license level power calibration being utilized for feature license activation/deactivation suitable for carrying out the various steps, processes, methods, and operations described herein is discussed with respect to FIG. 6, any of a variety of systems and/or processes may be utilized in accordance with embodiments of the disclosure. For example, the feature level or feature license power calibration may be implemented inside a network device. The elements depicted in FIG. 6 may also be interchangeable with other elements of FIGS. 1-5 and 7-8 as required to realize a particularly desired embodiment.

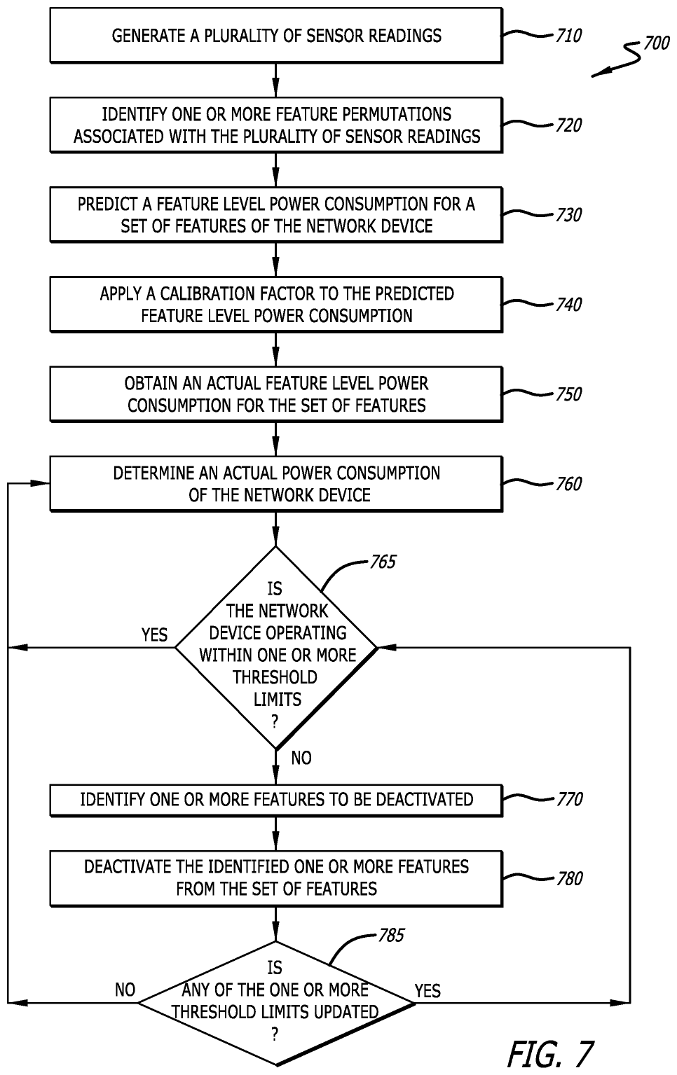

Referring to FIG. 7, a process 700 for feature level power calibration in network devices in accordance with various embodiments of the disclosure is shown. In many embodiments, the process 700 may generate a plurality of sensor readings (block 710). The plurality of sensor readings may be indicative of various parameters (e.g., voltage, current, temperature, or the like) of a network device. The network device may be associated with a set of features. The set of features may be determined (e.g., extracted) based on the current operating state and the configuration of the network device. Each feature may be a hardware feature, a software feature, or a combination thereof.

In a number of embodiments, the process 700 may identify one or more feature permutations associated with the plurality of sensor readings (block 720). In a variety of embodiments, the process 700 may predict a feature level power consumption for the set of features of the network device based on the plurality of sensor readings and the identified one or more feature permutations (block 730). A feature permutation may correspond to a unique subset of features, of the set of features, that are active at a given time instance. In some embodiments, a logistic regression analysis is executed on the plurality of sensor readings and the identified one or more feature permutations to predict the power consumed by each feature of the network device.

In more embodiments, the process 700 may apply a calibration factor to the predicted feature level power consumption (block 740). In additional embodiments, the process 700 may obtain an actual feature level power consumption for the set of features based on the application of the calibration factor to the predicted feature level power consumption (block 750). In further embodiments, the calibration factor applied for each feature may be the same. In still more embodiments, a different calibration factor can be applied for each feature. In still further embodiments, the same calibration factor may be applied for some features and different calibration factors may be applied for the remaining features.

Thus, the actual power consumed by each feature of the set of features can be determined. The calibrated power can be utilized for controlling various operations of the network device. In still additional embodiments, the process 700 may determine a power consumption of the network device (block 760). The power consumption of the network device may be determined based on one or more sensor readings of the plurality of sensor readings. A priority level and a power budget may be assigned to each feature of the set of features.

In some more embodiments, the process 700 can determine if the network device is operating within one or more threshold limits (block 765). In certain embodiments, the one or more threshold limits may be based on at least one sustainability goal set for the network device. In yet more embodiments, the one or more threshold limits may be dynamically adjustable values. In still yet more embodiments, the one or more threshold limits are updated based on a user input.

In many further embodiments, in response to the network device operating within the one or more threshold limits, the process 700 may determine the power consumption of the network device in a loop until the network device operates outside the one or more threshold limits. However, in many additional embodiments, in response to the network device operating outside the one or more threshold limits, the process 700 may identify one or more features to be deactivated (block 770). The one or more features to be deactivated are identified based on the actual power consumption of the set of features, the priority levels of the set of features, and the power budgets of the set of features. In many examples, the lower priority features consuming more than half of the corresponding power budgets may be identified for deactivation.

In still yet further embodiments, the process 700 may transmit a deactivation signal to the network device (block 780). The deactivation signal may be configured to deactivate the identified one or more features from the set of features. Based on the deactivation of the one or more features, the network device may start operating within the one or more threshold limits.

In still yet additional embodiments, the process 700 may determine if any of the one or more threshold limits are updated (block 785). In several embodiments, in response to none of the threshold limits being updated, the process 700 may determine the power consumption of the network device in a loop until the network device operates outside the one or more threshold limits. However, in several more embodiments, in response to at least one of the threshold limits being updated, the process 700 can determine if the network device is operating within one or more threshold limits.

Although a specific embodiment for a feature level power calibration being utilized for feature activation/deactivation suitable for carrying out the various steps, processes, methods, and operations described herein is discussed with respect to FIG. 7, any of a variety of systems and/or processes may be utilized in accordance with embodiments of the disclosure. For example, the feature level or feature license power calibration may be implemented for various other devices, such as mobile devices, computing devices, or the like. The elements depicted in FIG. 7 may also be interchangeable with other elements of FIGS. 1-6 and 8 as required to realize a particularly desired embodiment.

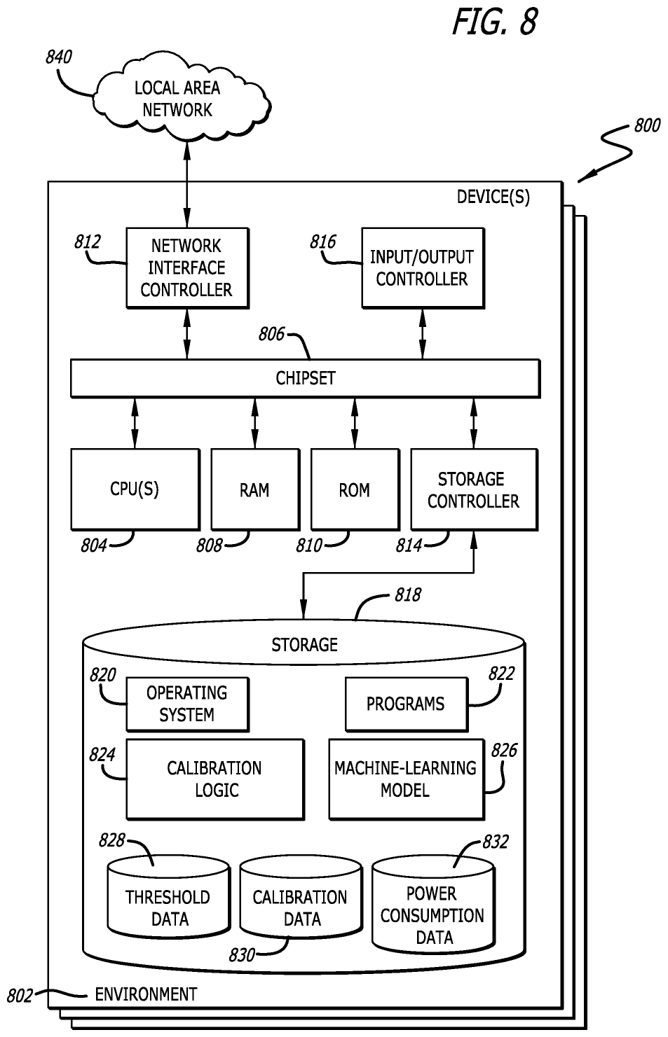

Referring to FIG. 8, a conceptual block diagram of a device 800 suitable for configuration with a calibration logic in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many nonlimiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, standard programmable central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface controller (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, threshold data 828, calibration data 830, and power consumption data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system 820 comprises the LINUX operating system. According to another embodiment, the operating system 820 comprises the WINDOWS® SERVER operating system from MICROSOFT Corporation of Redmond, Washington. According to further embodiments, the operating system 820 can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer executable instructions may be stored as application 822 and transform the device 800 by specifying how the processor(s) 804 can transition between states, as described above. In some embodiments, the device 800 has access to computer-readable storage media storing computer executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many further embodiments, the device 800 may include a calibration logic 824. The calibration logic 824 can be configured to perform one or more of the various steps, processes, operations, and/or other methods. Often, the calibration logic 824 can be a set of instructions stored within a non-volatile memory that, when executed by the processor(s)/controller(s) 804 can carry out these steps, etc. In some embodiments, the calibration logic 824 may be a client application that resides on a network-connected device, such as, but not limited to, a server, switch, personal or mobile computing device in a single or distributed arrangement.

In some embodiments, the calibration logic 824 can be configured to perform one or more of the various steps, processes, operations, and/or other methods described above in conjunction with FIGS. 1-7 for determining actual feature level power consumption and actual feature license level power consumption. For example, the calibration logic 824 may receive a plurality of sensor readings, identify one or more feature permutations, predict a feature level power consumption, apply a calibration factor, obtain actual feature level power consumption and actual feature license level power consumption for a set of features associated with the device 800 or other network devices. In certain embodiments, the calibration logic 824 can further activate and deactivate one or more features or feature licenses to ensure that the device 800 and/or the other network devices are operating within one or more threshold limits.

In still more embodiments, the threshold data 828 may store one or more threshold limits. In some examples, the one or more threshold limits may be based on at least one sustainability goal set for the device 800 or other network devices (e.g., switches, routers, hubs, servers, etc.) being monitored by the device 800. In some more examples, the one or more threshold limits may be dynamically adjustable values. The one or more threshold limits can be updated based on a user input or system feedback inputs. In yet more embodiments, the one or more threshold limits may set differently for an idle (or standby) device state and an active device state.

In still further embodiments, the calibration data 830 may store the calibration factor associated with the plurality of network devices. In scenarios where different calibration factors are determined for different features, the calibration data 830 may include multiple calibration factors associated each network device. Calibration factor can be a scalar value or a correction factor applied to predicted feature level power so as to align predicted feature level power consumption data with actual power consumption. The calibration data 830 can be utilized to correct errors, biases, or inaccuracies in predictions.

In still additional embodiments, the power consumption data 832 may store the predicted and the calibrated power consumption for the set of features and the set of feature licenses associated with the plurality of network devices. Such data can be used as feedback making decisions related to activation and deactivation of certain features when the device 800 or other associated network devices start operating outside the one or more threshold limits. Additionally, the predicted and the calibrated power consumption can be dynamically updated during a lifetime of the device to take in account device aging.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. In numerous embodiments, the ML model(s) 826 can be utilized to predict feature level power consumption for the set of features based on a plurality of sensor readings and one or more feature permutations associated with the plurality of sensor readings.

The ML model(s) 826 can be configured to generate inferences to make predictions or draw conclusions from data. An inference can be considered the output of a process of applying a model to new data. This can occur by learning from at least the threshold data 828, the calibration usage data 830 and the power consumption data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a calibration logic that is configured to:
receive a plurality of sensor readings associated with a network device, wherein the network device is associated with a set of features;
identify one or more feature permutations associated with the plurality of sensor readings;
predict a feature level power consumption for the set of features based on the plurality of sensor readings and the identified one or more feature permutations;
apply a calibration factor to the predicted feature level power consumption; and
obtain an actual feature level power consumption for the set of features based on an application of the calibration factor to the predicted feature level power consumption.

2. The device of claim 1, wherein a feature permutation of the one or more feature permutations corresponds to a unique subset of features of the set of features.

3. The device of claim 1, wherein at least one of the plurality of sensor readings includes a voltage reading.

4. The device of claim 1, wherein at least one of the plurality of sensor readings includes a current reading.

5. The device of claim 1, wherein the calibration logic is further configured to determine a power consumption of the network device based on one or more sensor readings.

6. The device of claim 5, wherein the calibration logic is further configured to determine, based on the power consumption of the network device, whether the network device is operating within one or more threshold limits.

7. The device of claim 6, wherein the one or more threshold limits are based on at least one sustainability goal set for the network device.

8. The device of claim 6, wherein the one or more threshold limits are dynamically adjustable values.

9. The device of claim 8, wherein the one or more threshold limits are updated based on a user input.

10. The device of claim 6, wherein the calibration logic is further configured to transmit a deactivation signal to the network device in response to determining that the network device is operating outside the one or more threshold limits, the deactivation signal being configured to deactivate one or more features from the set of features.

11. The device of claim 10, wherein the calibration logic is further configured to identify the one or more features to be deactivated based on the actual feature level power consumption of the set of features.

12. The device of claim 11, wherein based on the deactivation of the one or more features, the network device starts operating within the one or more threshold limits.

13. The device of claim 1, wherein the network device is associated with one or more feature licenses.

14. The device of claim 13, wherein a feature license of the one or more feature licenses comprises a subset of features from the set of features.

15. The device of claim 14, wherein the calibration logic is further configured to determine, based on the actual feature level power consumption, an actual power consumption of the one or more feature licenses.

16. The device of claim 15, wherein the calibration logic is further configured to determine a power consumption of the network device based on one or more sensor readings.

17. The device of claim 16, wherein the calibration logic is further configured to determine, based on the power consumption of the network device, whether the network device is operating within one or more threshold limits.

18. The device of claim 17, wherein the calibration logic is further configured to transmit a deactivation signal to the network device in response to determining that the network device is operating outside the one or more threshold limits, the deactivation signal being configured to deactivate at least one feature license of the one or more feature licenses.

19. A device, comprising:
one or more sensors configured to generate a plurality of sensor readings, wherein the device is associated with a set of features;
a processor;
a network interface controller configured to provide access to a network; and
a memory communicatively coupled to the processor, wherein the memory comprises a calibration logic that is configured to:
identify one or more feature permutations associated with the plurality of sensor readings;
predict a feature level power consumption for the set of features based on the plurality of sensor readings and the identified one or more feature permutations;
apply a calibration factor to the predicted feature level power consumption; and
obtain an actual feature level power consumption for the set of features based on an application of the calibration factor to the predicted feature level power consumption.

20. A method comprising:
receiving a plurality of sensor readings associated with a network device, wherein the network device is associated with a set of features;
identifying one or more feature permutations associated with the plurality of sensor readings;
predicting a feature level power consumption for the set of features based on the plurality of sensor readings and the identified one or more feature permutations;
applying a calibration factor to the predicted feature level power consumption; and
obtaining an actual feature level power consumption for the set of features based on an application of the calibration factor to the predicted feature level power consumption.
